(19) United States
(12) Patent Application Publication
(10) Pub. No.: US 2005/0250550 A1
(43) Pub. Date: Nov. 10, 2005

(54) Voice to text messaging system and method

(75) Inventor: Thomas Joseph Fields, Annandale, VA (US)

Correspondence Address: CROWELL & MORING LLP;INTELLECTUAL PROPERTY GROUP, P.O. BOX 14300, WASHINGTON, DC, 20044-4300, US

(73) Assignee: Nextel Communications, Inc.

(21) Appl. No.: 10/840,383

(22) Filed: May 7, 2004

(51) Int. Cl. H04M 1/00

(52) U.S. Cl. 455/567; 455/575.1

(57) ABSTRACT

A system and method for using a short message service (SMS) of a wireless communication network operates to convert a subscriber's voice to a text message. The system employs offline conversion and verification of the converted text message prior to transmitting the text message over the wireless communication network. The system is implemented within the subscriber unit handset such that no additional infrastructure modifications of the wireless communication network are required.

### FIELD OF THE INVENTION

The present invention relates to a system and method for performing text messaging in wireless communications.

### BACKGROUND OF THE INVENTION

Some wireless service providers allow for both “interconnect” and “dispatch” calls to be placed over a wireless network. Some interconnect capability is traditionally referred to as cellular communications offering duplex voice transmission via the use of dial-up calling. The dispatch capability is often referred to as a “walkie-talkie” communication using simplex voice transmission where only one party is capable of talking at any one time. Nextel Communication Inc. is a leading provider of such dual capability service, having subscriber units adapted for making both interconnect voice and dispatch voice calls. In a network such as Nextel's, the walkie-talkie feature is operated by a user selecting a number within an established “fleet” of subscribers, and having the user press a dispatch button to initiate the communication. The subscriber unit radio sends a signal including subscriber identification information, as well as the intended target number, to a cell site base station. Subsequently, a signal is sent to a dispatch application processor (DAP) through a frame relay switch called a Metro Packet Switch. The DAP identifies the target radio and signal with a distinctive tone to join the call.

On the other hand, an interconnect voice call is initiated when a user dials a telephone number and presses the “send” key on the subscriber unit. The telephone number, along with other data signals, passes over a radio channel to the base station which, in turn, relays the signals and the telephone number to main switching equipment. From the switching equipment, a message is passed to the Public Switched Telephone Network (PSTN) to connect with the target telephone number. When the called number answers, a “traffic channel” is assigned to the call.

Wireless networks additionally often include communication modes such as data transfer/text messaging. Text messaging takes the known form of the short messaging service (SMS), which allows point-to-point service by transmitting “short” messages to and from wireless handsets. The service uses a short message service center (SMSC) to store and forward short messages. The wireless network transports messages between the SMSCs and the subscriber units. With this service, an active subscriber unit, such as a mobile handset, can receive or transmit a short message at any time, independent of whether or not a voice or data call is in progress. The system guarantees delivery of the message with failures being identified and the message stored in the network until the destination is available. The primary advantageous characteristics of SMS include out-of-band packet delivery and low-bandwidth message transfer. The benefit of SMS to the user is convenience, flexibility and seamless integration of messaging services and data access. The subscriber unit (handset) thus becomes an extension of a computer, and eliminates the need for separate messaging devices.

Mobile handsets, such as cellular phone, PDAS, etc, are designed primarily to initiate and receive real-time voice communications. However, to accomplish text messaging, either a computer keyboard for entering the text, or simple phone menus provided on the keypad of the cell phone to enter text, are required. Alternatively, a user may enter letters using the phone keypad. In some instances, graphical user interfaces (GUIs) are utilized with the phones such that icons can simplify text entry. These icons are either on the phone keypad or represented on the display screen. Today, the use of text messaging is increasing due to its popularity, while it advantageously is less expensive than the cost of handling voice traffic due to differences in the required bandwidth.

Disadvantages associated with text messaging include the need for either a computer terminal or for the manipulation of a keypad and/or icons on a subscriber unit. Additionally, icons only allow for a very limited range of messages that can be sent, while a keypad takes up much more time to type detailed messages.

While telecommunication equipment companies and wireless service providers have heretofore focused on providing various forms of voice communication, there is a need to adequately address consumer demand with regard to facilitating text messaging.

### SUMMARY OF THE INVENTION

The present invention provides a system and method for performing text messaging in wireless communication which maintain the low cost advantages and other conveniences of text messaging without the disadvantages of data entry associated either with a keyboard or key pad of a subscriber unit handset.

The present invention advantageously utilizes a users most comfortable means of communicating to facilitate text messaging, i.e. the users' own speech and hearing capabilities. The most universal of “interfaces” provides an enhanced user comfort level while satisfying the needs for a simpler and more universal text messaging interface.

The present invention integrates voice recognition technology into phone handsets with a voice command. Therefore messages are converted into text without requiring a keyboard or without the need for tedious manipulation of a phone keypad.

According to the present invention, a sender may compose a message by speaking rather than by manipulation of the cell phone handset or typing on a keyboard.

It is a further aspect of the present invention to provide offline verification of a text message. The translated text message is made visible to the user of the handset for purposes of authentication prior to transmission.

Other aspects, features and techniques of the invention will be apparent to one skilled in the relevant art in view of the following detailed description of the invention.

### BRIEF DESCRIPTION OF THE DRAWINGS

FIG. 1 is a schematic block diagram of a mobile subscriber unit having voice to text circuitry according to the invention;

FIG. 2 is a block diagram illustrating a transmission operation according to the invention using a subscriber unit constructed in accordance with FIG. 1;

FIG. 3 is a flow chart of the voice to text messaging operation according to the present invention; and

FIG. 4 is another embodiment of a mobile subscriber unit according to the invention.

### DETAILED DESCRIPTION OF THE PREFERRED EMBODIMENTS

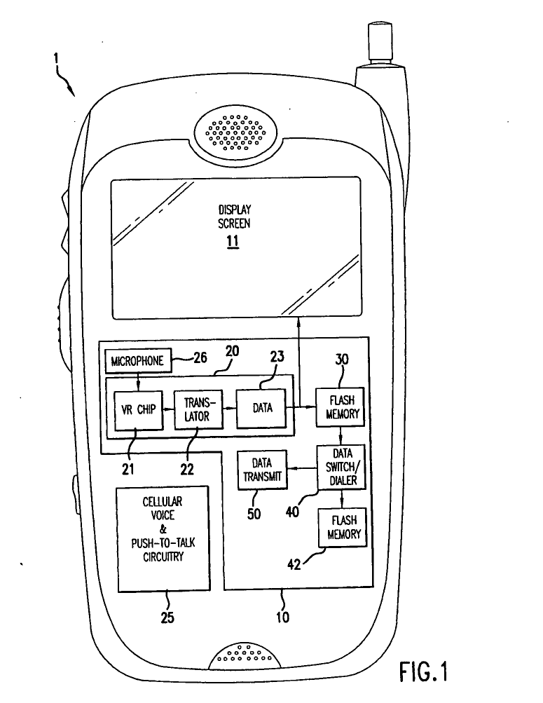

The voice recognition module 10 of FIG. 1 is integrated into a mobile subscriber unit such as a cellular handset 1. A display screen 11 corresponds to a conventional cell phone handset display. Modern subscriber units are able to provide multiple functions. For example, a Nextel Communications, Inc. unit, uses the Integrated Digital Enhanced Network (iDEN) to provide wireless, walkie-talkie and packet data types of wireless service from the same subscriber unit. The cellular service includes dial-up voice digital telephony service as well as fax, data and short messaging service (SMS). The walkie-talkie wireless radio service (dispatch) allows subscribers to communicate directly with one or more members of established groups. The packet data service allows subscribers full nationwide roaming and provides a bridge to the Internet. The voice and Direct Connect or dispatch features are available in the unit 1 through the known Cellular Voice and Push-to-Talk circuitry 25 of subscriber unit 1.

In order to take advantage of the benefits associated with the low frequency bandwidth requirements for short messaging service, the present invention provides an improved functionality to eliminate previous obstacles to practical usability. The voice recognition module 10, when activated, directs the output of the microphone 26 to a voice recorder chip 21 of a voice recognition system 20. The recorder chip 21 outputs information to translator 22 to provide data 23 which is then stored in flash memory 30. A user operated data switch/dialer 40, when activated, provides an output to transmit in a text messaging mode on a wireless network (not shown). This data switch 40 includes a dialer to direct and, subsequently, send the digitized text message to a particular end user. The text message is displayed on screen 11 until the process of dialing a number is completed. Additionally, a memory, such as flash memory 42, is provided to store the sent message for later recall.

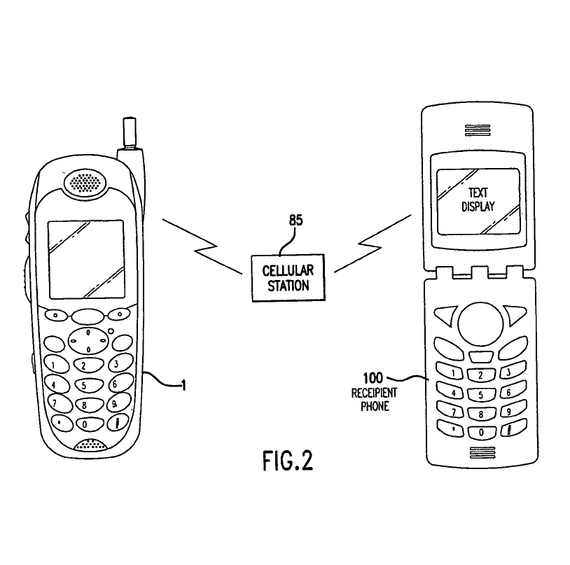

As illustrated in FIG. 2, the digitized text message is sent to the cellular station 85 via the text messaging mode. The message may be sent to multiple subscriber units including portable phones, e-mail accounts and the like. The recipient phone 100 may be a conventional phone capable of receiving text messages and need not be related to the voice recognition system. Of course, if the recipient phone also has a voice text module, the recipient may respond by recording a text message and sending it back to the user of phone 1. It is an important advantage of the invention that there is no need to modify the communication transmission network. The necessary modifications are made within the handset 1.

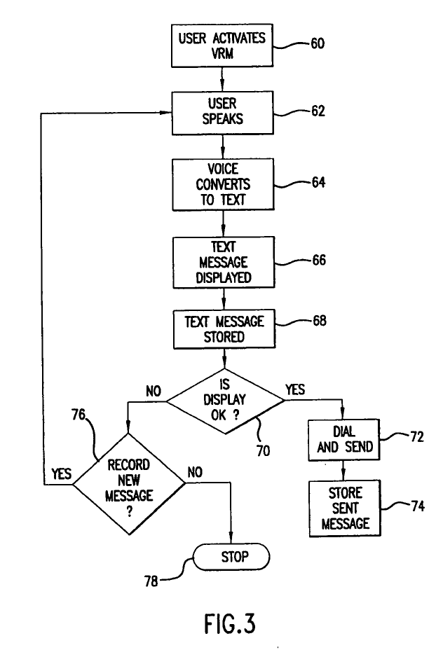

FIG. 3 is a flow chart illustrating the procedure for operating the voice recognition module 10 of FIG. 1. When a subscriber desires to use the voice to text module, an indicator on the cellular phone 1 is activated as a first step 60. Upon activation, the user may speak into the microphone at step 62. As a result the speech is converted from voice to text 64. The text message is then displayed on the display screen 11 in step 66 and stored in memory 30 in step 68. The user observes the text message that is displayed to see that it is satisfactory. If the text displayed is approved, the user then inputs the number of, or the address of, the person or group to whom the message is to be sent at step 72. When the call is connected, the text message is sent and the text is stored at 74 for later retrieval in a manner similar to storing previously called numbers.

With this procedure, it is possible to use a handset offline to construct a text message and to ensure its correctness before proceeding online to transmit the message. If the displayed text is not satisfactory, or contains errors, a query is made as to whether a new message is to be recorded at step 76. If no new message is to be recorded, and if it is not satisfactory, the process stops and the user may deactivate the voice recorder module operation (step 78). If a new message is desired, the process returns to step 62 where the user again records another message and/or restates the first message.

The above discussed activation of the voice recognition mode can be incorporated as one of the menu selections in a handset.

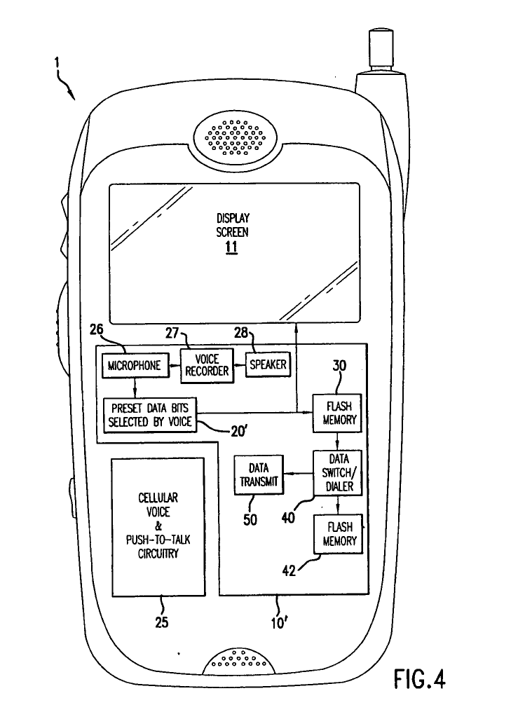

In the variation shown in FIG. 4, the user's speech can be recorded for playback instead of, or as an alternative to, the display of the text message. The voice is recorded by recorder 27 and fed to speaker 28 whenever playback is desired. The voice recording can also be used in conjunction with the embodiment of FIG. 1.

In another aspect of the variation of FIG. 4, the words spoken can be associated with preset data bits selected by voice command in a manner similar to speaking a name into the microphone, whereby the associated number is automatically dialed. According to this variation, the voice recognition module 10′ matches the output of microphone 26 with preset data bits 20′ before the text selected is displayed and stored in flash memory 30. The phone may also be equipped with a text to voice system, which would perform the reverse function for incoming text messages.

The present invention takes advantage of the benefits of short messaging services (SMS) without requiring additional system changes or user equipment or tedious operation of the handset.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1. A text messaging system for a telecommunications device, comprising:
a microphone;
a converting device for converting an output from said microphone into an alphanumeric output;
a display device for displaying said alphanumeric output;
a wireless transmission system having a frequency bandwidth adapted to maximized transmission of said alphanumeric output;
an activation device activated in response to authentication of said displayed alphanumeric output for transmitting said alphanumeric output on said wireless transmission system.

2. The system according to claim 1, wherein said activation device includes a dialing mechanism to direct said alphanumeric output to at least one defined end user.

3. The system according to claim 1, wherein said converting device includes a first memory device for storing said alphanumeric output.

4. The system according to claim 1, wherein said converting device includes a device for associating predefined alphanumeric portions with said output from said microphone.

5. The system according to claim 1, further including a voice recorder for recording the output of said microphone.

6. The system according to claim 1, further including a text to voice system for converting said transmitted alphanumeric output.

7. The system according to claim 1, wherein said wireless transmission system includes a voice transmission function.

8. The system according to claim 1, further including a storage device for storing said transmitted alphanumeric output.

9. The system according to claim 1, wherein said microphone, said display device and said activation devices are integrated in a mobile subscriber unit.

10. A method for wirelessly transmitting text messages via a telecommunications device, comprising:
converting a voice input from a user into a text message;
displaying said text message for the user;
determining whether said displayed text message is satisfactory to the user; and
transmitting said displayed text message over a wireless communication network upon determining that said displayed text message was satisfactory.

11. The method according to claim 10, wherein transmitting said displayed text message over a wireless communication network upon determining that said displayed text was satisfactory includes dialing a numeric code in order to direct said text message to at least one predefined end user.

12. The method according to claim 10, further including storing said text message to be displayed.

13. The method according to claim 10, wherein converting a voice input from a user into a text message includes associating predefined text portions with said voice input.

14. The system according to claim 10, further including recording said voice input.

15. The method according to claim 10, further including converting said transmitted text message to a voice output.

16. The method according to claim 10, further including storing said transmitted text message after determining whether said displayed text message is satisfactory to the user.

17. The method according to claim 10, wherein said converting, displaying, determining and transmitting are performed using a mobile subscriber unit.

18. The method according to claim 14, further including playing back the recorded voice input.

19. A subscriber unit for use with a wireless communication network, said subscriber unit comprising:
a handset housing;
a microphone arranged in the housing;
a voice recognition circuit coupled to said microphone for converting an output of said microphone into text data;
a display coupled to display said text data; and
an activation device for transmitting said text data over said wireless communication network.

20. The subscriber unit according to claim 19, wherein said activation device includes a dialing mechanism.

21. The subscriber unit according to claim 19, wherein said voice recognition circuit includes a first memory device for storing said text data.

22. The subscriber unit according to claim 19, wherein said voice recognition circuit includes a device for associating predefined text portions with said output of said microphone.

23. The subscriber unit according to claim 19, further including a voice recorder for recording the output of said microphone.

24. The subscriber unit according to claim 19, wherein said activation device further includes a memory for storing said transmitted text data.
